(19) United States
(12) Patent Application Publication
(10) Pub. No.: US 2023/0004601 A1
(43) Pub. Date: Jan. 5, 2023

(54) DETERMINING AND GENERATING SEARCH REFINERS FOR APPLICATIONS

(71) Applicant: Microsoft Technology Licensing, LLC, Redmond, WA (US)

(72) Inventors: Sabreena Shanthoshi RAJAN, Issaquah, WA (US); FNU SADHIKA, Bellevue, WA (US); Jingtian JIANG, Sammamish, WA (US); Byungki BYUN, Issaquah, WA (US); Rajkiran PANUGANTI, Bothell, WA (US); Philippe FAVRE, Bellevue, WA (US); Omar Z. KHAN, Clyde Hill, WA (US); Ye-Yi WANG, Kirkland, WA (US); Ankur GUPTA, Kirkland, WA (US); Ravi K. BIKKULA, Sammamish, WA (US); Guo MEI, Lynwood, WA (US); Carol Kumar Mekala, Woodinville, WA (US); Jeremy Michael Grubaugh, Kirkland, WA (US); Chad Michael Roberts, Snohomish, WA (US); Honghao Qiu, Issaquah, WA (US); Malik Mehdi Pradhan, Kirkland, WA (US); Anuja Milind Joshi, Pleasanton, CA (US); Rigoberto Saenz Imbacuan, Bogota (CO); Krishn Ramesh, Hamilton (CA); Adarsh Sridhar, Issaquah, WA (US)

(73) Assignee: Microsoft Technology Licensing, LLC, Redmond, WA (US)

(21) Appl. No.: 17/364,130

(22) Filed: Jun. 30, 2021

(51) Int. Cl. G06F 16/9035; G06F 16/903

(52) U.S. Cl. CPC G06F 16/9035; G06F 16/90335

(57) ABSTRACT

The present application describes a system and method for searching for content items in an application executing on a computing device. In order to increase the efficiency of the search, the present disclosure provides a refiner that is used to filter or otherwise refine search results. The refiner is user-specific and/or tenant/entity-specific. The refiner may be based on long-term aggregated data and/or contextual information associated with the user.

### BACKGROUND

Searching for content items in a particular application, such as an email application, can be frustrating. For example, it may be difficult for a user to identify a desired content item using a keyword because many content items, including both the desired content item and undesired content items, may share or otherwise be associated with the same keyword.

### SUMMARY

The present application describes an improved system and method for searching for content items in an application executing on or otherwise associated with a computing device. In order to increase the efficiency of the search, the present disclosure provides a refiner that is used to filter or otherwise refine search results. The refiner is user-specific and/or tenant/entity-specific. The refiner may be based on long-term aggregated data and/or contextual information associated with the user of the computing device.

Accordingly, the present application describes a method for filtering search results. In an example, the method includes receiving a search term from a computing device and performing a search using the search term to identify search results. The search results may include one or more content items. A refiner from a plurality of user-specific refiners is identified. In an example, the refiner is identified, based at least in part, on contextual information associated with a user that provided the search term to the computing device. The search results and the refiner are provided to the computing device. When the refiner is selected, the search results are filtered using the refiner and the filtered search results are provided to the computing device.

The present application also describes a system that includes processor and a memory coupled to the processor and storing instructions that, when executed by the processor, perform operations. In an example, the operations include analyzing content of content items associated with a user and generating a plurality of user-specific refiners based, at least in part, on the analyzing. A search term, provided in a user interface of an electronic messaging application, is received and used to identify search results. A refiner from the plurality of user-specific refiners is identified. The refiner and the search results are provided to the user interface of the electronic messaging application.

Also described is a method for refining search results. In an example the method includes receiving a search term in a user interface of an electronic messaging application and identifying search results based, at least in part, on the search term. A topic-based refiner is identified from a plurality of user-specific topic-based refiners. In an example, the topic-based refiner is identified based, at least in part, on contextual information associated with a user. Search results and the topic-based refiner are provided in the user interface of the electronic messaging application. Based on receiving a selection of the topic-based refiner, the search results are filtered.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1A illustrates an example system for refining search results according to an example.

FIG. 1B illustrates the example system of FIG. 1A in which a search query is provided to a search refiner system according to an example.

FIG. 1C illustrates the system of FIG. 1B in which search results are filtered using the refiner according to an example.

FIG. 2A illustrates an example user interface of a messaging application that may use a refiner to filter search results according to an example.

FIG. 2B illustrates a refiner being appended to a search query in the user interface of the messaging application.

FIG. 2C illustrates the example user interface of the messaging application in which multiple different refiners are displayed according to an example.

FIG. 3 illustrates a method for identifying a refiner to filter search results according to an example.

FIG. 4 is a block diagram of a computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present application describes the generation, identification, and/or use of a refiner that enables a user to conduct efficient searches for content items that are stored in a data storage system. The data storage system may be a local data storage system or a remote data storage system. The content items and the refiners described herein may be used across or otherwise be associated with a number of different applications and/or platforms. For example, the content item may be a message, for example, an email message, in a messaging application, for example, an email application, and the refiner may be associated with a topic of the message. In another example, the content item may be a document in a collaborative workspace environment and the refiner may be associated with an individual that created the document or most recently edited the document.

As indicated above, the refiner enables more efficient searches for content items to be conducted when compared with a simple keyword search. For example, when searching for an email message in an email application, a user typically provides a search term in a user interface and subsequently scrolls through a list of search results to find the specific message she is looking for. This is time consuming and can be frustrating for the user.

In order to address the above, the present application describes the generation, identification, and use of refiners. Refiners may be used to filter search results that are received by a computing device in response to the user submitting a search query.

Continuing with the example above, when searching for an email message in an email application, the user provides a search term in a user interface and receives a number of search results and one or more refiners. In this example, each refiner is associated with a particular topic. A topic may be identified based on subject matter contained within or otherwise associated with the search results. For example, rather than mining each email in the search results for keywords or key phrases, the system described herein analyzes the content of the emails (and/or other content items) the user interacts with over a period of time to identify subject matter and/or topics that are significant to the user. Once the topics are identified, topic-based refiners are generated and may be associated with various emails and other content items. Thus, when search results are received, the search results, along with any associated topic-based refiners, may be provided to the user.

Upon selection of one of the provided refiners, the search results are filtered such that only email messages that are associated with the topic are provided in the user interface. In an example, the one or more refiners may be arranged in a hierarchy. Thus, in response to a selection of a first refiner associated with the first topic, additional refiners associated with sub-topics of the first topic (or topics associated with the first topic) may be provided in the user interface. Selection of one of the additional refiners may further filter the search results. Although the example above discloses use of topic refiners, other refiners may be used. These include, but are not limited to, dynamically determined time/date refiners, dynamically determined person/people refiners, and/or dynamically determined keyword refiners.

The refiners that are generated, identified, and/or used may be specific to a particular user. For example, in the case of topic refiners, topics may be generated, determined, and/or identified using long-term aggregated data based off a semantic model associated with a particular user. Thus, topics that are truly significant to the user may be identified. In another example, a refiner may be associated with a particular entity. For example, the entity may provide a service and/or products. In such an example, a keyword or phrase may identify the service and/or products and a refiner may be associated with the keyword or phrase and/or generated using the keyword or phrase.

In yet another example, recent interactions between the user and one or more content items may be identified. The topic of the content item(s) may be identified or determined and subsequently used to determine a topic that is currently (or recently) relevant to the user.

Accordingly, the present disclosure provides a plurality of technical benefits including but not limited to: generating and ranking multiple refiners for a search query, leveraging a wide range of knowledge during a query to understand topics and/or people that are currently relevant to a particular user, providing improved search results using various machine learning or artificial intelligence systems that understand and learn what a user is interested in and/or working on based on historical, recent, and/or current interactions with various content items, and using user responses to improve refiner selection and generation, among other examples.

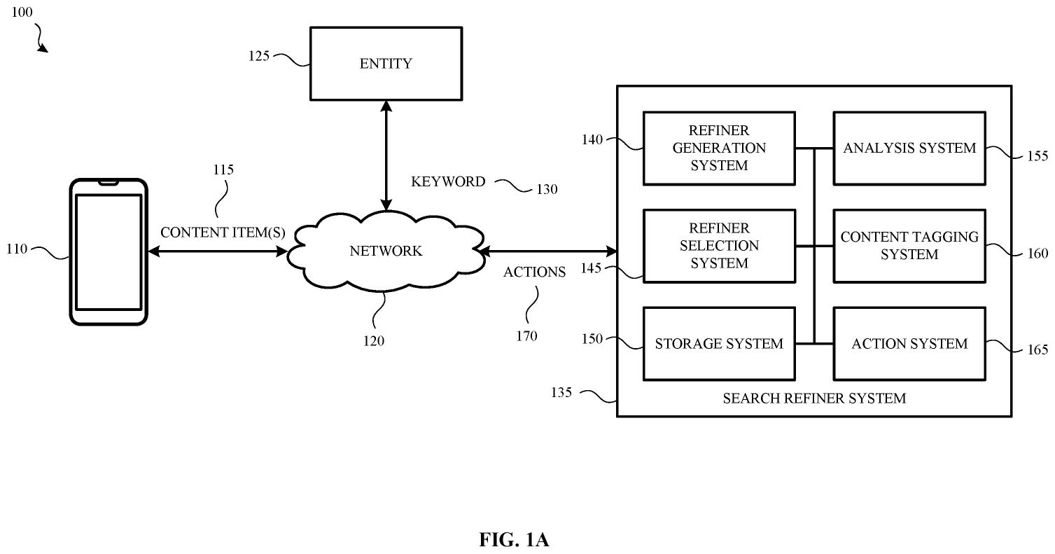

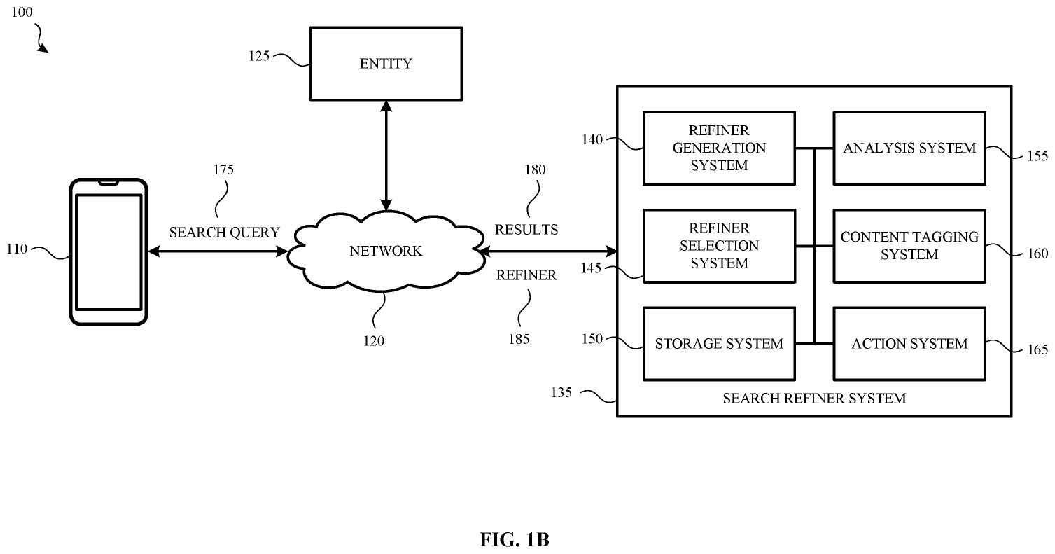

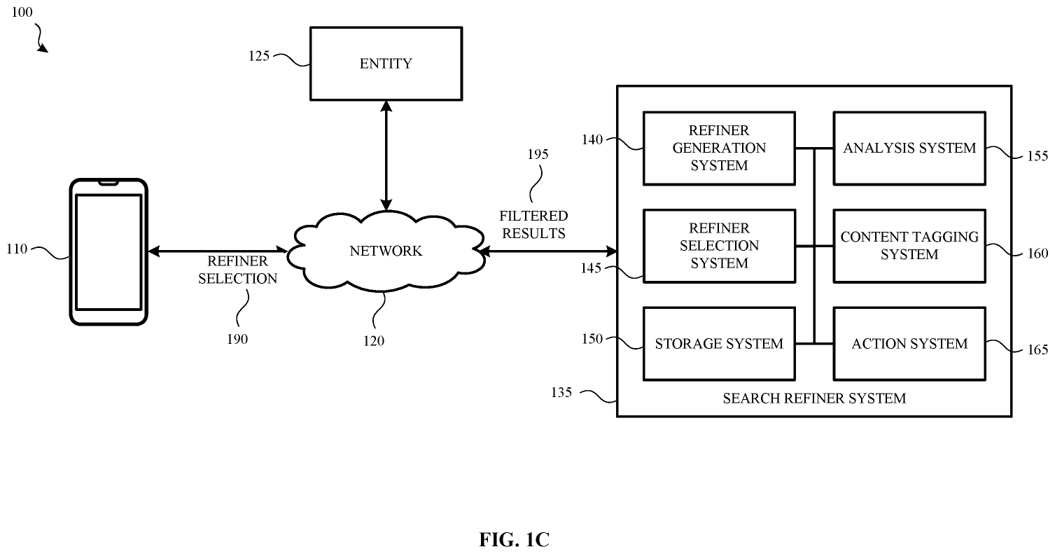

These and other examples will be described in more detail with respect to FIG. 1A-FIG. 4.

FIG. 1A illustrates an example system 100 for refining search results according to an example. The system 100 may be used to generate, identify, and/or use one or more refiners to filter search results of a search query. The system 100 may generate, identify, and/or use a number of different types of refiners—either alone or in combination, to filter search results. For example, the refiners may include topic refiners, keyword refiners, people refiners, and property refiners. Likewise, the received query, and subsequent search results, may be associated with various content items (e.g., email messages, text messages, posts, documents, audio and/or video files, meeting requests, and images). Additionally, the search request may be provided in and/or across any number of different applications such as, for example, email applications, collaborative workspace environments, productivity applications, and the like.

The system 100 generates, identifies, and uses refiners that are specific to a particular user. In an example, a user of a computing device 110 may create, interact with, or otherwise be associated with a number of different content items. For example, the user may receive various email messages via an email application, may post and/or interact with particular content on social networking application, may collaborate on a document or file with other individuals via a collaborative workspace environment, may set up meetings with various individuals and/or be notified about events via a calendaring application, or may send and/or receive messages via a messaging application. As the user interacts with the various content items described above, the system may generate candidate refiners. The candidate refiners may subsequently be used to filter search results that are received by the computing device 110 in response to the user of the computing device 110 submitting a search query (e.g., search query 175 (FIG. 1B)).

Each candidate refiner may be based on content provided in or otherwise associated with a content item 115. For example, a computing device 110 may receive, create, or otherwise access a content item 115. In an example, the content item 115 may be an email message, text message, meeting request, and/or an attachment received by a messaging application of the computing device 110 via a network 120. In another example, the content item 115 may be a document, a file, a post, an image, and/or an audio/video file that is received and/or accessed by the computing device 110. In an example, the content item 115 may be accessed by the computing device 110 via a collaborative workspace environment or a social media application or site. In yet another example, the content item 115 may be stored in a remote storage system or a local storage system.

As shown in FIG. 1A, the system 100 includes a search refiner system 135. The search refiner system 135 may be communicatively coupled to the computing device 110 via the network 120. In another example, the search refiner system 135, or the various systems of the search refiner system 135, may be integrated or otherwise associated with the computing device 110.

The search refiner system 135 may include an analysis system 155. The analysis system 155 analyzes content contained in each content item 115. In an example, the analysis system 155 analyzes content of the content item 115 when a content item 115 is received by the computing device 110. For example, the content item 115 may be an email received or sent by the computing device 110 via an email application. As the email is sent and/or received by the computing device 110, the analysis system 155 analyzes the content of the email in order to learn the subject matter, topics, projects, people, etc., the user of the computing device 110 is involved in and/or interacting with.

As part of the analysis, the analysis system 155 may extract or otherwise identify one or more keywords or phrases associated with the content item 155. In an example, the analysis system 155 employs various machine learning algorithms to learn the various projects, topics, people, etc., the user of the computing device 110 is involved with/in. For example, the analysis system 155 may utilize data (collected over a period of time) from a semantic model to determine the meaning of content in various content items 115 and/or to determine relationships between various content items. The analysis system 155 may periodically, continuously, or substantially continuously analyze various content items 115 to help ensure the search refiner system 135 is consistently learning the topics, projects, people, etc., the user is interacting with.

In another example, the analysis system 155 may identify metadata associated with the content item 115. The metadata may include a content item identifier (e.g., email identifier or conversation identifier), a message sender identifier, a message recipient identifier, a content item identifier, date and/or time information, a content creator identifier, message status indicators (read/unread, high importance), message attachment indicators, and so on. The metadata may also be used to determine the various projects, topics, people, etc. the user of the computing device 110 is engaged with/in.

In an example, the metadata may be combined or otherwise associated with the projects, topics, and/or people the user interacts with. Thus, metadata may be used to dynamically generate and/or identify one or more refiners to be displayed with search results. For example, if the user performs a search in an email application for a particular individual (e.g., John Jones), the analysis system 155 may determine that emails to and/or from John Jones typically include attachments. The analysis system 155 may also determine that emails to and/or from John Jones include content that is related to or is otherwise wise associated with a particular project (e.g., Project X). Accordingly, the refiners that are ultimately presented to the user (discussed in more detail below) may include a “Has Attachment” refiner and/or a “Project X” refiner.

Continuing with the example above, the metadata may also include information that emails to and/or from John Jones, typically include John Stewart and/or occurred during a particular time frame (e.g., June 2021). Accordingly, a “John Stewart” refiner and/or a “June 2021” may be provided to the user via the user interface along with the “Has Attachment” refiner and/or the “Project X” refiner.

The search refiner system 135 may also include a content tagging system 160. The content tagging system 160 may tag the various content items 115 with identifiers based on the analysis performed by the analysis system 155. For example, if the analysis system 155 determines that a topic of a particular content item 115 relates to Project X, the content tagging system 160 may tag the content item with a “Project X” topic tag. In another example, the content tagging system 160 may determine that the content of a content item 155 relates to patents associated with Project X. Accordingly, the content item 115 may be tagged with a “patents” tag, a “Project X” tag, or a “Project X patents” tag.

In another example, if the analysis system 155 determines that a particular content item 115 was sent or created by a particular individual (e.g., John Jones), the content tagging system 160 may tag that content item 115 with a people/person tag that identifies the particular individual. In an example, a content item 115 may have a single tag or multiple tags.

In another example, a content item 115 may be associated with a keyword 130. The keyword 130 may be generated or otherwise identified by the analysis system 155. For example, the analysis system 155 may analyze the content item 115 and identify, based on the content in the content item 115, a keyword or keywords that are associated with the content item 115.

In another example, the computing device 110 and/or the search refiner system 135 may be associated with a particular entity 125. For example, a user of the computing device 110 may be an employee of the entity 125. The entity 125 may offer particular goods and/or services and the keyword 130 may identify those goods and/or services.

For example, the analysis system 155 may identify the keywords 130 associated with the entity 125 and/or receive the various keywords 130 from the entity 125. The analysis system 155 and/or the content tagging system 160 may use the keywords 130 as part of the analysis and/or tagging process described above. Accordingly, the search refiner system 135 may generate the candidate list of user-specific refiners, entity-specific refiners, or a combination thereof using the various tags and keywords 130.

For example, as content items 115 are analyzed and tagged, a refiner generation system 140 may generate a list of candidate refiners. Each refiner in the list of candidate refiners may include or otherwise be associated with information and/or metadata that is used to identify the refiner and/or used to determine how the refiner would filter search results should the refiner be selected. The information may include the subject matter and/or topic associated with the refiner, a person identified by the refiner, a date or range of dates associated with the refiner, an entity associated with the refiner, and so on.

However, as additional content items 115 are received, the refiner generation system 140, using various machine learning algorithms and/or artificial intelligence, may update (e.g., add, delete, modify) the various refiners (and the information/metadata associated with the various refiners) based on metadata, analyzed content of content items, and/or tags associated with the content items. Thus, the search refiner system 135 may dynamically determine the most up-to-date topics, people, projects, etc., the user of the computing device 110 is working on or is otherwise associated with.

The search refiner system 135 may also include an action system 165. The action system 165 may receive contextual information (represented as actions 170) associated with the user of the computing device 110. The actions 170 may include interactions between the user and a content item 115. The interactions may be reading a content item 115, opening a content item 115, deleting a content item 115, editing a content item 115, selecting at least a portion of a content item 115, creating a content item 115, and so on. The actions 170 may be used to provide additional information on the content items 115, topics, people, etc., that are relevant to the user of the computing device 110.

For example, as the actions 170 are received by the action system 165, the action system 165 may identify or otherwise provide context associated with the action 170 and the content item 115. This information may then be provided to the refiner generation system 140 which may generate, edit, and/or update the user-specific refiners, the entity-specific refiners, or a combination of user-specific and entity-specific refiners.

In an example, the search refiner system 135 may also include a refiner selection system 145. The refiner selection system 145 may select one or more refiners based on a rank or score associated with each of the candidate refiners. In an example, the candidate refiners may be ranked and presented to a user based on a ranking algorithm or process. For example, the ranking algorithm determine contextual information associated with a refiner (described in more detail below) and provide a score to the refiner based on the contextual information. The scores of each of the refiners may be compared against each other to determine the rank.

The score and/or the rank of each refiner may be dynamic. Additionally, the score and/or the rank of each refiner may be associated with a particular user and/or a particular search term. For example, a first user may be associated with a first set of ranked refiners while a second user may be associated with a second, different set of ranked refiners. In another example, a first set of search results may be associated with a first set of refiners while a second set of search results may be associated with a second, different set of ranked refiners. As such, each user that accesses the search refiner system 135 can be presented with the most relevant and/or useful candidate refiners with minimal effort.

In an example, the ranking algorithm may consider various factors when determining a rank or score of a refiner. For example, the factors to be considered may include one or more of: top ranked content items (e.g., top ranked emails, messages, documents), a date and/or timestamp associated with the content item, relevance of a content item with respect to a particular keyword or topic, past engagements with a particular refiner, a recency of engagement, type of engagement with respect to different types of refiners (e.g., topic refiners or people refiners), people associated or involved with the content item, a number of times the particular content items have been revisited, additional content items associated with the content item (e.g., whether an email includes an attachment), and so on.

In other examples, the factors that may be considered when ranking the refiners may include a frequency of use of a refiner, a frequency of a keyword associated with a refiner, a frequency of topics/content in a content item, information gain, query types (e.g., whether the query is for a topic, a person, or an entity), entropy minimization, statistical information, and so on. In an example, the ranking of each refiner may be dynamically updated in real-time or substantially real-time based, at least in part, on identified actions 170. Additionally, the ranking of each refiner may be updated in real-time or substantially real-time based on received search queries 175 and/or user selection such as will be described in more detail below.

The search refiner system 135 may also include a storage system 150. The storage system 150 may store various content items 115, the candidate refiners and/or the rank of each candidate refiner. As content items 115 are created, received, edited, opened, or otherwise interacted with, the storage system 150 may store any associated updates to the content items 115. Likewise, the storage system 150 may update the list of candidate refiners and/or the rank of each candidate refiner.

FIG. 1B illustrates the example system 100 of FIG. 1A in which a search query 175 is provided to the search refiner system 135 according to an example. The search query 175 may be a query for one or more content items 115 (FIG. 1A) stored by the storage system 150 of the search refiner system 135. Although the storage system 150 is shown as being part of the search refiner system 125, the storage system 150 may be a remote storage system (e.g., a cloud storage system) or a local storage system (e.g., a storage system of the computing device 110).

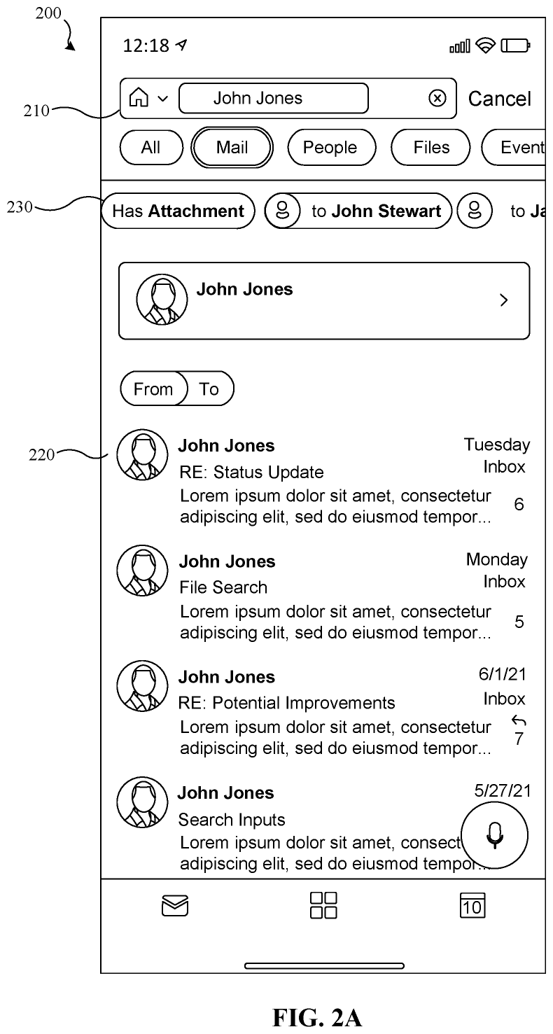

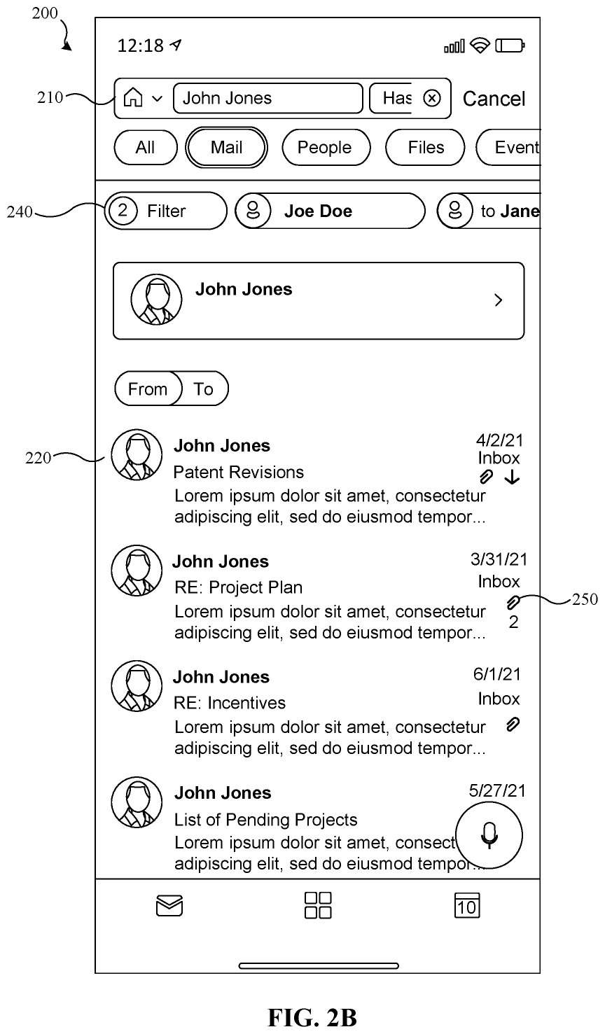

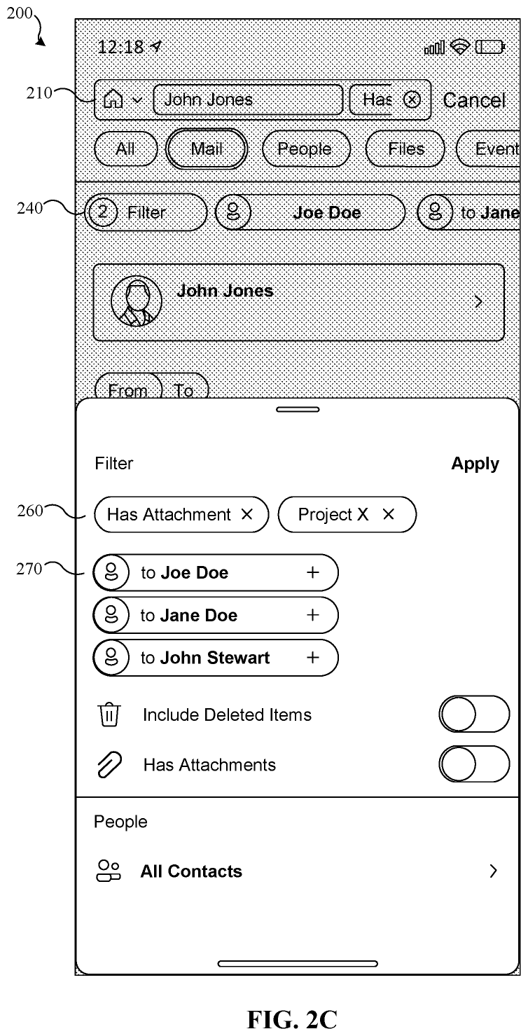

To initiate a search, the user of the computing device 110 may provide a search term for a particular content item 115 in a user interface of the computing device 110. For example, the user may provide a search term in order to locate an email in a messaging application. Accordingly, the user may access a user interface of the messaging application (e.g., the user interface 200 (FIG. 2A)) and provide the search query 175. Upon receipt of the search query 175, the computing device 110 provides the search query 175, via the network 120, to the search refiner system 135. In an example, the search query 175 is a keyword, a phrase, a person, a topic, a title, a time and/or date, or any combination thereof.

Upon the receipt of the search query 175, the search refiner system 135 may identify and return one or more results 180. In an example, the results 180 may be identified based on matching the keyword of the search query 175 with the same or a similar keyword contained in or otherwise associated with the content item 115. Although a specific example has been given, the results 180 may be identified using other techniques.

The content items contained in the results 180 may be ranked. In an example, the content items in the results 180 may be ranked based on a time and/or date associated with the content item. For example, if the search query 175 includes a keyword search for a particular email, the emails in the results 180 may be ranked and/or presented in a user interface of the computing device 110 based on when the user received the email. In another example, if the search query 175 is a search for a particular document in a collaborative workspace environment, the documents in the results 180 may ranked and/or presented to the user based on when the user last accessed the document (e.g., the document the user accessed most recently would be presented first).

In another example, the content items in the results 180 may be ranked based on a determined relevance of the content items with respect to the search query 175. For example, when the search query 175 is received, the analysis system 155 may use various machine learning algorithms or artificial intelligence to identify content items that include content that is related to or otherwise associated with the search query 175.

In addition to returning the results 180, the search refiner system 135 may also return a refiner 185 to the computing device 110. The refiner 185 may be selected by the refiner selection system 145 and may be based on what the search refiner system 135 knows about the user of the computing device 110. For example, the returned refiner 185 may be dynamically identified based on topics that are relevant to the user, documents that are relevant to the user, people that the user interacts with, projects that the user is involved with, dates of interactions with particular content items, projects and/or individuals, and so on. This information may be collected over a long period of time or recent interactions such as described above.

For example, the action system 165 may track or otherwise receive information corresponding to the user's interactions with various content items. As such, the action system 165, either alone or in combination with the analysis system 155, may determine what topics, documents, people, and/or projects are currently relevant to the user. The interactions may range from recent interactions (e.g., within the last thirty seconds) to historical interactions (e.g., within the last thirty days).

Continuing with the example above, if the user interacts with a particular content item that is identified as being related to or otherwise corresponding to a particular topic (e.g., patents), a refiner 185 that corresponds to patents, or is otherwise related to patents, may be identified. In another example, if the user had a meeting with a particular individual (e.g., John Jones) about a particular project (e.g., Project X), the name of the individual and/or the name of the particular project may be identified as a refiner 185. In yet another example, a refiner 185 may be selected by the refiner selection system 145 based on a determined similarity between tags associated with the content items in the results 180 and information and/or metadata (e.g., a name, topic, subject matter, date, etc.) associated with a refiner. In another example, a refiner 185 may be selected by the refiner selection system 145 based on a determined similarity between tags associated with the content items in the results 180 and the keywords in the search query 175. In another example, the refiner 185 may be selected based on the keyword 130 associated with the entity 125.

Candidate refiners may be generated by the refiner generation system 140 based on content items 115 the user of the computing device 110 has interacted with. As such, the refiner selection system 145 may select one or more refiners 185 based on a determined similarity score between one or more candidate refiners and the content of the content items associated with the results 180.

In an example, the refiner selection system 145 may identify a number of different candidate refiners that are associated with the results 180. The refiner selection system 145 may then select a predetermined number of refiners to provide to the computing device 110 along with the results 180. The predetermined number may be based on user preference, type of computing device, or size of the user interface provided on the computing device 110. For example, the user may indicate that she wants to see three to five refiners 185 when results 180 are received. In another example, the search refiner system 135 may determine (based on information provided by the computing device 110) that the user interface of the computing device has a limited amount of space to display multiple refiners 185. Accordingly, the refiner selection system 145 may select two refiners 185 to display in the user interface.

In another example, the refiner generation system 140, either alone or in combination with the various other systems, may determine that additional refiners should be generated and provided to the computing device 110 based on a received search query 175. For example, the refiner selection system 145 may determine that some or all available candidate refiners 185 will not provide desired coverage and/or diversity to meet required or recommended coverage and/or diversity thresholds with respect to the search query 175. Accordingly, the refiner generation system 140 may dynamically generate new candidate refiners and provide the candidate refiners to the refiner selection system 145.

As indicated above, each candidate refiner may be dynamically ranked based on contextual information associated with the user, the results 180, the search query 175 and/or topics, people, time/date information, and so on. In another example, the ranking may be based on an information gain associated with each refiner 185. The information gain may be analyzed in view of the user of the computing device 110, the search query 175, and/or the results 180. In an example, refiners 185 with a higher information gain may be ranked higher than refiners with a lower information gain.

As used herein, information gain is a difference in entropy between a feature that is being used and one that is not. In this example, the feature is a refiner. As such, the information gain of a particular refiner or various candidate refiners measure the entropy difference before and after refinement. For example, a refiner with a high information gain is one that splits the results 180 into two different sets. For example, a topic refiner may split the results 180 into a first set (e.g., a set in which content items relate to or are otherwise associated with the topic) and a second set (e.g., a set in which content items do not relate to or are not otherwise associated with the topic).

In an example, the information gain may be associated with an information gain threshold. For example, in order for a refiner to be ranked or otherwise selected for a particular search query 175, the information gain may need to be over a threshold. The information gain threshold may be based on the number of results 180. For example, if the results 180 include twenty content items, the information gain threshold may be one in which seven to ten content items would be filtered out from the results 180 should the refiner be applied to the results 180. Although specific numbers have been specified, this is for example purposes only. In an example, the information gain may be one in which an optimal point or range of points in a parabolic curve is detected.

In another example, the ranking of the refiner 185 may be based on whether the search query 175 is a topic-based query or a person-based query. For example, a person-based query may be weighted more heavily when compared to a topic-based query. As such, a refiner 185 associated with a person may be ranked higher than a refiner 185 associated with a topic.

In another example, past behavior of the user may influence the ranking of a refiner 185. For example, the refiner selection system 145 and/or the action system 165 may track the number of times a particular refiner 185 has been selected by the user of the computing device 110. This ranking may also be associated with the search query 175. For example, the user may select a particular refiner or set of refiners when a first search query is executed and select a second, different refiner or set of refiners when a second, different search query is executed. In another example, a similarity score between the content of the content items in the results 180 and the content/topic of the refiner 185 may influence the ranking of refiners 185. Although specific examples are given, the refiner selection system 145 may use various machine learning algorithms and/or artificial intelligence to determine and/or update the ranking of the various refiners.

In yet another example, a refiner 185 may be selected and/or ranked based on a determined coverage of the refiner 185 and/or a diversity of a refiner 185. The refiner selection system 145 may help ensure that the suggested refiners 185 (e.g., the highest ranked refiners of the candidate refiners) cover a diverse set of results. For example, the refiner selection system 145, either alone or in combination with the analysis system 155, may analyze content items in the results 180 in view of a first refiner and a second refiner to help ensure that there is little to no overlap of content items associated with each refiner.

For example, the results 180 may include twenty content items that are associated with the search query 175. In this example, the first refiner may identify fifteen content items as being relevant to the user. Likewise, the second refiner may identify thirteen content items as being relevant to the user. Additionally, of the fifteen content items identified by the first refiner as being relevant to the user and the thirteen content items identified by the second refiner as being relevant to the user, ten content items may overlap (e.g., the same ten content items are included in the fifteen content items identified by the first refiner and in the thirteen content items identified by the second refiner). As such, the diversity of content items provided by the first refiner and the second refiner may not exceed a diversity threshold. Accordingly, the refiner selection system 145 would provide only one of the first refiner or the second refiner to the computing device 110.

In another example, a coverage of identified refiners may be required to exceed a coverage threshold. For example, the identified refiners should cover as may content items as possible to help ensure that content items that are original to the search query 175 are not discarded. For example, the results 180 may include twenty content items that are associated with the search query 175. In this example, selection of a first refiner may cause eight content items to be filtered from the results 180 while leaving twelve content items remaining. Likewise, selection of a second refiner may cause the twelve content items to be filtered from the results 180 while the other eight content items remain. Thus, although content items are filtered out based on the selection of either the first refiner or the second refiner, all of the content items associated with the original search query 175 are represented by either the first refiner or the second refiner.

Although specific examples are given, the coverage may be associated with a particular coverage threshold. For example, if twenty content items are included in the results 180, eighteen of the results may need to be represented by any combination of refiners (e.g., a first refiner is associated with six results, a second refiner is associated with five results and a third refiner is associated with seven results).

In an example, the refiner selection system 145, either alone or in combination with the analysis system 155, may use machine learning algorithms and/or artificial intelligence to determine the coverage associated with the various refiners 185 with respect to the results 180.

Turning to FIG. 1C, once the refiners are ranked and the highest ranked refiners are provided to the computing device 110, the user may select one or more refiners (shown as refiner selection 190). Upon selection of the refiner, the refiner may be appended to or otherwise associated with the initial search query 175 and a filtered set of content items (represented as filtered results 195) is provided to the computing device 110. Although the filtered results 195 are shown as being provided by the search refiner system 135, the computing device 110 may be configured to locally filter the content items that are part of the results 180.

FIG. 2A illustrates an example user interface 200 of a messaging application that may use a refiner to filter search results 220 according to an example. The user interface 200 may be provided on a computing device such as, for example, computing device 110 shown and described with respect to FIG. 1A.

As shown in FIG. 2A, the user interface 200 includes a search box 210. In the example shown in FIG. 2A, a user has provided a search query of “John Jones.” In response, various search results 220 have been provided to the user interface 200. Additionally, a search refiner system (e.g., the search refiner system 135 (FIG. 1A)) has generated and/or identified various refiners 230. The refiners 230 are provided in the user interface 200.

In the example shown, the refiners 230 include a “Has Attachment” refiner and a “John Stewart” refiner. Although specific refiners 230 are shown, other refiners and types of refiners may be provided in the user interface 200. For example, and based on the content of the search results 220 and/or contextual information associated with the user that provided the search term, a refiner associated with a particular topic (e.g., Project X) may also be provided in the user interface 200.

In FIG. 2B, the user has selected the “Has Attachment” refiner. Accordingly, the search box 210 now includes the original search query (e.g., John Jones) as well as the Has Attachment refiner. As shown, the Has Attachment refiner has been appended or otherwise added to the original search query. Additionally, and in response to the selection of the Has Attachment refiner, the search results 220 only include content items (e.g., email messages) that have attachments (indicated by the paperclip indicator 250).

The user interface 200 also includes an indicator 240 that provides information on the number of filters that are currently being applied to the search results 220. In this example, two different filters/refiners are applied to the search results 220. Additional refiners (e.g., Joe Doe and Jane Doe) are also provided on the user interface 200.

Upon selection of the indicator 240, and with reference to FIG. 2C, the user interface 200 may display the filters/refiners 260 that are currently being applied to the search results 220. In this example, the filters/refiners 260 include the Has Attachment refiner and a “Project X” refiner. The user interface 200 may also display other suggested refiners 270. In this example, the suggested refiners 270 include a “Joe Doe” refiner, a “Jane Doe” refiner and a “John Stewart” refiner. Although the suggested refiners 270 include people refiners, the suggested refiners 270 may include topic refiners, time/date refiners, and so on.

Each refiner 260 may be removed from the search query 210 upon selection of the “x” associated with the refiner 260. Likewise, one or more suggested refiners 270 may be added to the search query 210 upon selection of the “+” associated with the suggested refiner 270. The user interface 200 will display updated search results 220 based on any selection.

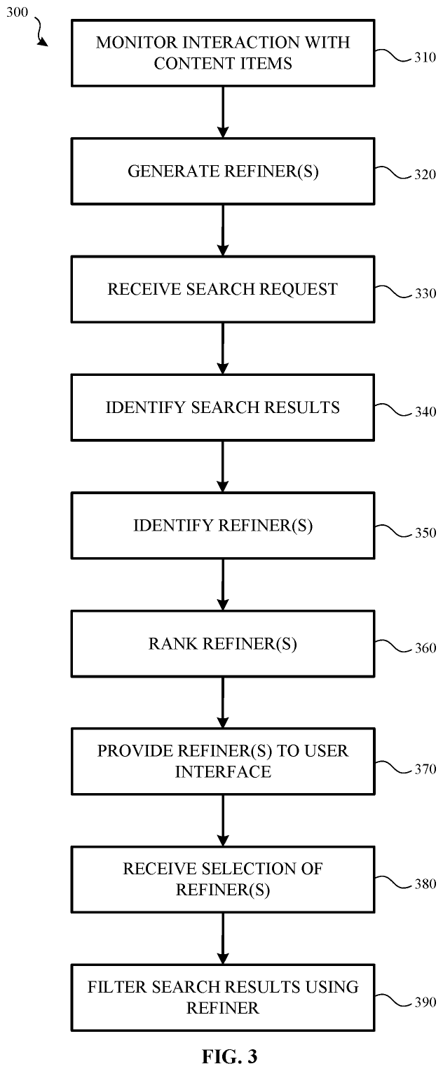

FIG. 3 illustrates a method 300 for identifying a refiner to filter search results according to an example. The method 300 may be executed by a search refiner system, or various systems of a search refiner system such as, for example, the search refiner system 135 shown and described with respect to FIG. 1A-FIG. 1C.

Method 300 begins when the search refiner system monitors (310) user interactions with various content items. The monitored interactions may include receipt of a content item, creation of a content item, editing a content item, and so on.

Based on the monitored interaction, the search refiner system may generate (320) one or more candidate refiners. The candidate refiners may be generated based on analyzing content and/or data provided in or otherwise associated with the content items. For example, a refiner may be generated based on a topic associated with a content item. In another example, a refiner may be generated based on a creator or sender of a content item. In yet another example, a refiner may be generated based on a date and/or timestamp associated with the content item. In another example, a refiner may be generated based on one or more keywords associated with an entity.

The search refiner system may receive (330) a search request. The search request may include a keyword that identifies one or more content items. In response to receiving the search request, one or more search results may be identified (340). The search results may be identified based on a similarity between the keyword and the content of the various content items.

In addition to identifying search results, the search refiner system identifies (350) one or more refiners that may be used to filter the identified search results. In an example, the one or more refiners are identified from the generated refiners from operation 320. The identified refiners may be ranked based at least in part, on various factors. These factors may include, one or more of the following: one or more keywords in the search request, the content of content items provided in the search results, metadata associated with the content items in the search results, historical user interaction with content items, historical user interaction with one or more refiners, a determined information gain (e.g., whether an information gain threshold has been met or exceeded), a determined diversity threshold, a determined coverage threshold, and so on.

Once the refiners are identified, the search refiner system may rank (360) the identified refiners. In an example, the identifiers may be ranked using contextual information and/or history-based information/features. For example, identifiers that may be associated with the context of the search results may be ranked higher than those that are not associated with the context of the search results. In another example, refiners that have been previously selected in other search queries/results may be ranked higher than other refiners that have not been selected or have not been recently selected. In some examples, the ranking of the refiners may be updated in real-time or substantially real-time. For example, as refiners are selected (e.g., such as in operation 380 below), the ranking of refiners may be updated to reflect recent selections/input. Accordingly, the search refiner system may dynamically determine what content items are relevant to a user at a given time.

The ranked refiners, along with the search results, are provided (370) to a user interface of a computing device. Once the refiners are provided to the user interface, the search refiner system may receive (380) a user selection of the one or more of the refiners. In response to receiving the selection, the search results may be filtered (390) using the refiner. In an example, the search results are filtered by appending the refiner to the search term that was provided in the search request.

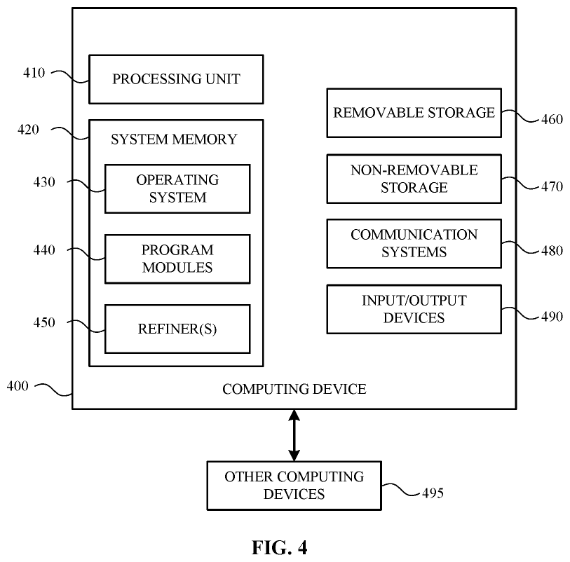

FIG. 4 is a system diagram of a computing device 400 according to an example. The computing device 400, or various components and systems of the computing device 400, may be integrated or associated with a search refiner system, an analysis system, an action system, a refiner generation system, a refiner selection system, a storage system, a content tagging system as well as the various systems described herein. As shown in FIG. 4, the physical components (e.g., hardware) of the computing device are illustrated and these physical components may be used to practice the various aspects of the present disclosure.

The computing device 400 may include at least one processing unit 410 and a system memory 420. The system memory 420 may include, but is not limited to, volatile storage (e.g., random access memory), non-volatile storage (e.g., read-only memory), flash memory, or any combination of such memories. The system memory 420 may also include an operating system 430 that controls the operation of the computing device 400 and one or more program modules 440. The program modules 440 may be responsible for determining refiner(s) 450, filtering search results based on the refiners, ranking refiners, and so on. A number of different program modules and data files may be stored in the system memory 420. While executing on the processing unit 410, the program modules 440 may perform the various processes described above.

The computing device 400 may also have additional features or functionality. For example, the computing device 400 may include additional data storage devices (e.g., removable and/or non-removable storage devices) such as, for example, magnetic disks, optical disks, or tape. These additional storage devices are labeled as a removable storage 460 and a non-removable storage 470.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units, and various application functionality all of which are integrated (or “burned”) onto the chip substrate as a single integrated circuit.

When operating via a SOC, the functionality, described herein, may be operated via application-specific logic integrated with other components of the computing device 400 on the single integrated circuit (chip). The disclosure may also be practiced using other technologies capable of performing logical operations such as, for example, AND, OR, and NOT, including but not limited to mechanical, optical, fluidic, and quantum technologies.

The computing device 400 may include one or more communication systems 480 that enable the computing device 400 to communicate with other computing devices 495 such as, for example, routing engines, gateways, signings systems, and the like. Examples of communication systems 480 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 400 may also have one or more input devices and/or one or more output devices shown as input/output devices 490. These input/output devices 490 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage 460, and the non-removable storage 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Based on the above, non-limiting examples of the present disclosure describe a method for filtering search results. In an example, the method includes receiving, from a computing device, a search term; performing a search using the search term to identify search results, the search results including one or more content items; identifying a refiner from a plurality of user-specific refiners, the identified refiner being identified, based at least in part, on contextual information associated with a user that provided the search term to the computing device; providing the search results to the computing device; providing the refiner to the computing device; and based on receiving a selection of the refiner from the computing device: filtering the search results based, at least in part, on the refiner; and providing the filtered search results to the computing device. In an example, the method further comprises analyzing the one or more content items to determine a tag associated with one or more content items; and comparing the tag of the one or more content items to information associated with the refiner. In an example, the method further comprises determining a first set of the search results that are associated with the refiner and a second set of the search results that are not associated with refiner; and determining whether the first set of the search results in view of the second set of the search results meet a threshold. In an example, the plurality of user-specific refiners are determined based, at least in part, on an analysis of content in the one or more content items. In an example, the refiner is: a topic-based refiner; a name of an individual that is associated with the content item; or associated with a date. In an example, the method further comprises identifying an additional refiner when the filtered search results are provided in the user interface. In an example, the method further comprises providing the additional refiner in the user interface. In an example, the contextual information is based, at least in part, on an interaction with another content item. In an example, the another content item is a document or an electronic message provided in a messaging application. In an example, the contextual information is based, at least in part, on a keyword associated with an entity.

The present application also describes a system, comprising: a processor; and a memory coupled to the processor and storing instructions that, when executed by the processor, perform operations, comprising: analyzing content of content items associated with a user; generating a plurality of user-specific refiners based, at least in part, on the analyzing; receiving a search term provided in a user interface of an electronic messaging application; identifying search results based, at least in part, on the search term; identifying a refiner from the plurality of user-specific refiners; and providing the refiner and the search results in the user interface of the electronic messaging application. In an example, the instructions further comprise instructions for analyzing the search results to determine a topic associated with the search results; and comparing the topic associated with the search results with topic information associated with the refiner. In an example, the instructions further comprise instructions for determining an information gain associated with each refiner in the plurality of user-specific refiners in view of the search results; and identifying the refiner based, at least in part, on the refiner meeting an information gain threshold. In an example, the instructions further comprise instructions for identifying a topic associated with each content item of the content items associated with the user, the topic associated with each content item being based, at least in part, on the analyzing; and for each identified topic, associating a particular user-specific refiner of the plurality of user-specific refiners with the identified topic. In an example, the instructions further comprise instructions for receiving a selection of the refiner in the user interface of the electronic messaging application. In an example, the instructions further comprise instructions for filtering the search results based, at least in part, on the received selection of the refiner in the user interface of the electronic messaging application. In an example, the instructions further comprise instructions for determining contextual information associated with each user-specific refiner of the plurality of user-specific refiners; and ranking the plurality of user-specific refiners based, at least in part, on the contextual information. In an example, the instructions further comprise instructions for determining a score of the contextual information associated with each user-specific refiner; and ordering each user-specific refiner based, at least in part, on the score.

The present application also describes a method for refining search results, comprising: receiving a search term in a user interface of an electronic messaging application; identifying search results based, at least in part, on the search term; identifying a topic-based refiner from a plurality of user-specific topic-based refiners, the topic-based refiner being identified based, at least in part, on contextual information associated with a user; providing search results and the topic-based refiner in the user interface of the electronic messaging application; and based on receiving a selection of the topic-based refiner, filtering the search results. In an example, the method also comprises analyzing the search results to determine a topic associated with the search results; and determining which topic-based refiners of the plurality of user-specific topic-based refiners are associated with the topic.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included, or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for filtering search results, comprising:
receiving, from a computing device, a search term;
performing a search using the search term to identify search results, the search results including one or more content items;
identifying a refiner from a plurality of user-specific refiners, the identified refiner being identified, based at least in part, on contextual information associated with a user that provided the search term to the computing device;
providing the search results to the computing device;
providing the refiner to the computing device; and
based on receiving a selection of the refiner from the computing device:
filtering the search results based, at least in part, on the refiner; and
providing the filtered search results to the computing device.

2. The method of claim 1, further comprising:
analyzing the one or more content items to determine a tag associated with one or more content items; and
comparing the tag of the one or more content items to information associated with the refiner.

3. The method of claim 1, further comprising:
determining a first set of the search results that are associated with the refiner and a second set of the search results that are not associated with refiner; and
determining whether the first set of the search results in view of the second set of the search results meet a threshold.

4. The method of claim 1, wherein the plurality of user-specific refiners are determined based, at least in part, on an analysis of content in the one or more content items.

5. The method of claim 1, wherein the refiner is:
a topic-based refiner;
a name of an individual that is associated with the content item; or
associated with a date.

6. The method of claim 1, further comprising identifying an additional refiner when the filtered search results are provided in the user interface.

7. The method of claim 6, further comprising providing the additional refiner in the user interface.

8. The method of claim 1, wherein the contextual information is based, at least in part, on an interaction with another content item.

9. The method of claim 8, wherein the another content item is a document or an electronic message provided in a messaging application.

10. The method of claim 1, wherein the contextual information is based, at least in part, on a keyword associated with an entity.

11. A system, comprising:
a processor; and
a memory coupled to the processor and storing instructions that, when executed by the processor, perform operations, comprising:
analyzing content of content items associated with a user;
generating a plurality of user-specific refiners based, at least in part, on the analyzing;
receiving a search term provided in a user interface of an electronic messaging application;
identifying search results based, at least in part, on the search term;
identifying a refiner from the plurality of user-specific refiners; and
providing the refiner and the search results in the user interface of the electronic messaging application.

12. The system of claim 11, wherein the instructions for identifying the refiner further comprise instructions for:
analyzing the search results to determine a topic associated with the search results; and
comparing the topic associated with the search results with topic information associated with the refiner.

13. The system of claim 11, wherein the instructions for identifying the refiner further comprise instructions for:
determining an information gain associated with each refiner in the plurality of user-specific refiners in view of the search results; and
identifying the refiner based, at least in part, on the refiner meeting an information gain threshold.

14. The system of claim 11, wherein the instructions for generating the plurality of user-specific refiners further comprise instructions for:
identifying a topic associated with each content item of the content items associated with the user, the topic associated with each content item being based, at least in part, on the analyzing; and
for each identified topic, associating a particular user-specific refiner of the plurality of user-specific refiners with the identified topic.

15. The system of claim 11, further comprising instructions for receiving a selection of the refiner in the user interface of the electronic messaging application.

16. The system of claim 15, further comprising instructions for filtering the search results based, at least in part, on the received selection of the refiner in the user interface of the electronic messaging application.

17. The system of claim 11, further comprising instructions for:
determining contextual information associated with each user-specific refiner of the plurality of user-specific refiners; and
ranking the plurality of user-specific refiners based, at least in part, on the contextual information.

18. The system of claim 17, wherein the instructions for ranking the plurality of user-specific refiners based, at least in part, on the contextual information further comprise instructions for:
determining a score of the contextual information associated with each user-specific refiner; and
ordering each user-specific refiner based, at least in part, on the score.

19. A method for refining search results, comprising:
receiving a search term in a user interface of an electronic messaging application;
identifying search results based, at least in part, on the search term;
identifying a topic-based refiner from a plurality of user-specific topic-based refiners, the topic-based refiner being identified based, at least in part, on contextual information associated with a user;
providing search results and the topic-based refiner in the user interface of the electronic messaging application; and
based on receiving a selection of the topic-based refiner, filtering the search results.

20. The method of claim 19, further comprising:
analyzing the search results to determine a topic associated with the search results; and
determining which topic-based refiners of the plurality of user-specific topic-based refiners are associated with the topic.
